(19) United States
(12) Patent Application Publication
(10) Pub. No.: US 2025/0352001 A1
(43) Pub. Date: Nov. 20, 2025

(54) COFFEE CAPSULE MACHINE EQUIPPED WITH RECOGNITION ASSEMBLY FOR CAPSULE HOLDER SPECIFICATION

(71) Applicant: ZHEJIANG TIANXIKITCHEN APPLIANCE CO.,LTD., LISHUI (CN)

(72) Inventors: JUN YUAN, LISHUI (CN); YUQING LIANG, LISHUI (CN); TINGBIN TANG, LISHUI (CN); DEQUAN CAI, LISHUI (CN); KAIHONG MA, LISHUI (CN); XIYAN CHEN, LISHUI (CN); TING LYU, LISHUI (CN)

(21) Appl. No.: 19/283,263

(22) Filed: Jul. 29, 2025

(30) Foreign Application Priority Data
Aug. 21, 2024 (CN) 202411157328.4

(51) Int. Cl. A47J 42/44

(52) U.S. Cl. CPC A47J 42/44

(57) ABSTRACT

The present invention provides a coffee capsule machine equipped with recognition assembly for capsule holder specification, comprising: a housing provided with a powder discharge port configured to interface with the capsule holder; a capsule holder mechanism disposed on the housing, the capsule holder mechanism including a supporting base for placing the capsule holder; and a recognition assembly for capsule holder specification disposed on the housing and configured to identify the specification of the capsule holder placed on the supporting base. The invention automatically identifies the specification of the capsule holder on the supporting base and feeds this information back to the grinding mechanism, enabling the grinding mechanism to grind an appropriate amount of coffee powder. The coffee capsule machine of the present invention is capable of producing coffee capsules of multiple specifications, thereby meeting the needs of a wider range of users.

### TECHNICAL FIELD

The present invention relates to the technical field of coffee capsule machines, and more particularly to a coffee capsule machine equipped with recognition assembly for capsule holder specification.

### BACKGROUND

When a coffee capsule machine operates, the grinding mechanism grinds coffee beans into coffee powder, which then falls into the capsule holder to produce coffee capsules for convenient brewing. Most coffee capsule machines in the prior art can only produce capsules of a single specification and cannot meet the diverse needs of different consumer groups in the market. In particular, when replacing capsule holders of different specifications which may vary in diameter, height, and other dimensions, machines in the prior art are unable to automatically identify the specifications or models of the capsule holders. As a result, the grinding mechanism will grind coffee beans according to a preset amount, which can lead to coffee powder either overflowing from the capsule holder or failing to fill it completely during the filling process.

### SUMMARY

The present invention provides a coffee capsule machine equipped with recognition assembly for capsule holder specification, aiming to address the problem in the prior art wherein coffee capsule machines cannot automatically identify capsule holders of different specifications, resulting in coffee powder either overflowing from the capsule holder or failing to fill it completely during the filling process.

To solve the above technical problem, the technical solution adopted by the present invention is as follows:

A coffee capsule machine equipped with recognition assembly for capsule holder specification, comprising:
a housing provided with a powder discharge port configured to interface with a capsule holder;
a capsule holder mechanism disposed on the housing, the capsule holder mechanism including a supporting base configured to place the capsule holder; and
a recognition assembly for capsule holder specification disposed on the housing and configured to identify a specification of the capsule holder placed on the supporting base.

As a further embodiment, the capsule holder mechanism further includes a driving assembly configured to drive the supporting base to ascend along the housing such that the capsule holder on the supporting base engages with the powder discharge port, or to descend along the housing such that the capsule holder on the supporting base disengages from the powder discharge port.

The recognition assembly comprises a first sensor and a second sensor both disposed on the housing, and a first trigger and a second trigger both disposed on the capsule holder mechanism and configured to ascend or descend synchronously with the supporting base along the housing;

When the driving assembly drives the supporting base to ascend along the housing, the first trigger activates the first sensor at least once, with each activation generating a sensing signal; When the second trigger activates the second sensor, the driving assembly stops; The specification of the capsule holder on the supporting base is determined based on a number of times the first sensor is activated.

Based on the above technical embodiment, the driving assembly is configured to drive the supporting base to ascend along the housing so that the capsule holder on the supporting base engages with the powder discharge port, or to descend so that the capsule holder on the supporting base disengages from the powder discharge port, facilitating the user in removing the capsule holder.

When the driving assembly drives the supporting base to ascend, the first trigger first activates the first sensor to generate a sensing signal. After the capsule holder is properly engaged with the powder discharge port, the second trigger activates the second sensor, causing the driving assembly to stop. This prevents the capsule holder from continuing to ascend and ensures that capsule holders of different specifications can be properly aligned with the powder discharge port. During the ascending process of the capsule holder along with the supporting base, due to the differing heights of capsule holders of different specifications, the number of times the first trigger activates the first sensor also differs. The specification of the capsule holder can be determined based on the number of activations of the first sensor.

The above configuration enables not only automatic recognition of the capsule holder specification during the process in which the driving assembly drives the capsule holder to ascend and engage with the powder discharge port, but also ensures that capsule holders of different specifications can be properly aligned with the powder discharge port.

As a further embodiment, the first trigger is provided with at least one triggering portion.

When the number of triggering portions is two or more, all the triggering portions are arranged from top to bottom along a lifting direction of the supporting base.

Based on the above technical embodiment, the configuration makes use of the height differences among capsule holders of different specifications. Different positions of the triggering portions correspond to capsule holders of different heights. During the ascending process of the capsule holder driven by the driving assembly, a capsule holder with a greater height will only cause one of the triggering portions to activate the first sensor and generate a single signal, whereas a capsule holder with a smaller height may cause two or more triggering portions to activate the first sensor and generate two or more signals. As a result, the capsule holder specification recognition assembly is simplified and achieves more accurate recognition.

As a further embodiment, a connecting assembly is provided between the driving assembly and the supporting base; the driving assembly drives the supporting base to ascend or descend via the connecting assembly, and the first trigger is disposed on the connecting assembly.

As a further embodiment, the coffee capsule machine further includes a capsule holder disposed on the supporting base, wherein the second trigger is arranged at an upper end of the capsule holder.

Based on the above technical embodiment, by arranging the second trigger at the upper end of the capsule holder, the second sensor can only be activated when the capsule holder is fully engaged with the powder discharge port during the upward movement driven by the driving assembly. This causes the driving assembly to stop, thereby halting the upward movement of the capsule holder and maintaining its position in engagement with the powder discharge port.

As a further embodiment, the second sensor is disposed on the housing. When the capsule holder completes engagement with the powder discharge port, the second trigger activates the second sensor, and the driving assembly stops.

Based on the above technical embodiment, the second sensor is arranged on the side of the powder discharge port, which facilitates the upward movement of the capsule holder for engagement with the powder discharge port, and ensures that the second trigger can activate the second sensor when the capsule holder reaches the engagement position.

As a further embodiment, the first sensor is a first photoelectric switch, and the first trigger is a light-blocking plate.

Based on the above technical embodiment, the light-blocking plate generates a signal by interrupting the first photoelectric switch, thereby enhancing detection sensitivity.

As a further embodiment, the second sensor is a second photoelectric switch. A mounting portion is provided on the housing at a side of the powder discharge port. The second photoelectric switch includes a receiver and a transmitter mounted on the mounting portion. The receiver and the transmitter are respectively arranged on opposite sides of the powder discharge port and face each other.

Based on the above technical embodiment, the second photoelectric switch includes a receiver and a transmitter positioned on opposite sides of the powder discharge port. When the driving assembly drives the capsule holder upward, the second trigger on the capsule holder interrupts the second photoelectric switch upon reaching the engagement position with the powder discharge port. This configuration also facilitates convenient installation of the second photoelectric switch.

As a further embodiment, a third sensor is also provided within the housing, and the third sensor is located below the first sensor.

When the driving assembly drives the supporting base to descend along the housing and the first trigger activates the third sensor, the driving assembly stops.

Based on the above technical embodiment, by providing the third sensor, when the driving assembly drives the capsule holder to move downward from the powder receiving position, and the first trigger activates the third sensor, the driving assembly stops. This allows the supporting base and capsule holder to reach the lowest position, facilitating the user's retrieval and placement of the capsule holder.

As a further embodiment, the third sensor is a third photoelectric switch, and the first trigger is a light-blocking plate.

The present invention provides the following beneficial effects:

The present invention provides a recognition assembly for capsule specification disposed on the housing of a coffee capsule machine, which is configured to automatically identify the specification of the capsule holder mounted on the supporting base. The identified specification is then transmitted through the system to the grinding mechanism, enabling the grinding mechanism to grind an appropriate amount of coffee powder based on the identified capacity of the capsule holder. As a result, the coffee capsule machine of the present invention is capable of producing coffee capsules of various specifications, thereby meeting the needs of a wider range of users.

### BRIEF DESCRIPTION OF THE DRAWINGS

In order to more clearly illustrate the technical solutions of the embodiments of the present invention, the drawings required for describing the embodiments are briefly introduced below. It should be understood that the following drawings merely depict certain embodiments of the present invention and therefore should not be regarded as limitations of the scope of the invention. For those skilled in the art, other related drawings may also be obtained based on these drawings without making any creative efforts.

FIG. 1 is a cross-sectional structural diagram of the coffee capsule machine equipped with recognition assembly for capsule holder specification in the present invention.

FIG. 2 is a structural diagram of the capsule holder and the second sensor in the present invention.

FIG. 3 is a structural diagram of the first capsule holder placed on the supporting base in the present invention.

FIG. 4 is a structural diagram of the second capsule holder placed on the supporting base in the present invention.

FIG. 5 is a structural diagram of the third capsule holder placed on the supporting base in the present invention.

The reference numbers in the drawings are as follows:
Housing 1; Mounting Portion 11; Powder Discharge Port 12; Capsule Holder Mechanism 13; Recognition assembly for capsule holder specification 14; Second Trigger 15; Connecting Assembly 16; Supporting base 2; First Sensor 3; Second Sensor 4; Receiver 41; Transmitter 42; Third Sensor 5; First Trigger 6; First Triggering Portion 61; Second Triggering Portion 62; Third Triggering Portion 63; Driving Assembly 7; Nut 71; Lead Screw 72; Mounting Base 73; Connecting Frame 74; First Capsule Holder 8; Second Capsule Holder 9; Third Capsule Holder 10.

### DETAILED DESCRIPTION OF EMBODIMENTS

The technical solutions in the embodiments of the present invention will be illustrated in detail in combination with the accompanying drawings. It should be understood that the specific embodiments described herein are merely intended to explain the present invention and are not intended to limit the present invention. Based on the embodiments of the present invention, all other embodiments obtained by those skilled in the art without making creative efforts shall fall within the scope of protection of the present invention.

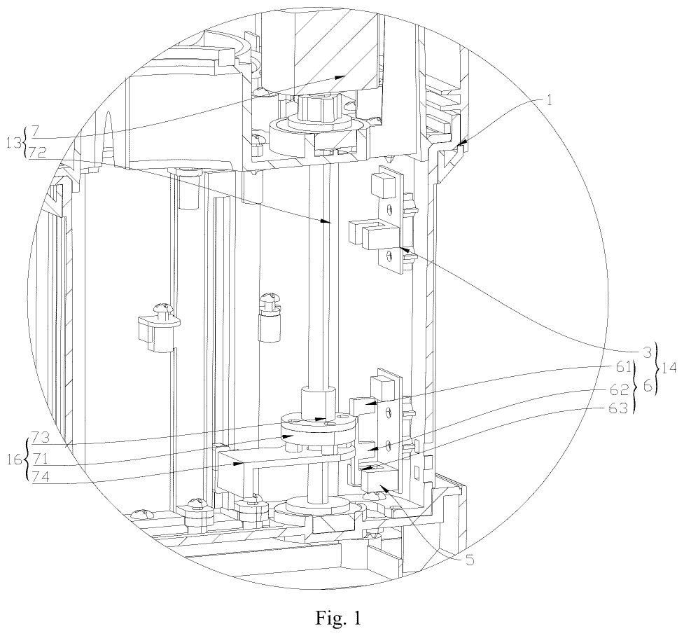

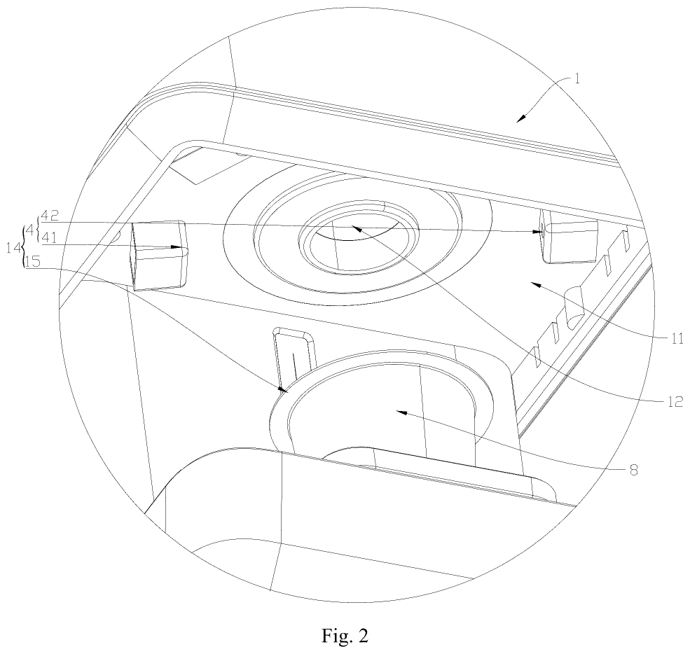

As shown in FIGS. 1 and 2, the present embodiment provides a coffee capsule machine equipped with a recognition assembly 14 for capsule holder specification, comprising:
a housing 1 provided with a powder discharge port 12 configured to interface with a capsule holder;
a capsule holder mechanism 13 disposed on the housing 1, the capsule holder mechanism 13 including a supporting base 2 configured to hold the capsule holder; and
a recognition assembly 14 for capsule holder specification disposed on the housing 1 and configured to identify the specification of the capsule holder placed on the supporting base 2.

Specifically, after the capsule holder is engaged with the powder discharge port 12, it is used to receive coffee powder. The recognition assembly 14 is configured to automatically identify the specification of the capsule holder placed on the supporting base 2. The identified specification can then be transmitted to the grinding mechanism, which grinds a predetermined amount of coffee powder in a single operation based on the identified specification of the capsule holder.

In this embodiment, as shown in FIGS. 1 and 2, the capsule holder mechanism 13 further includes a driving assembly 7 configured to drive the supporting base 2 to ascend along the housing 1 so that the capsule holder on the supporting base 2 engages with the powder discharge port 12, or to descend along the housing 1 so that the capsule holder on the supporting base 2 disengages from the powder discharge port 12.

The recognition assembly 14 includes a first sensor 3 and a second sensor 4 disposed on the housing 1, as well as a first trigger 6 and a second trigger 15 disposed on the capsule holder lifting mechanism, which ascend and descend synchronously with the supporting base 2 along the housing 1.

When the driving assembly 7 drives the supporting base 2 to ascend along the housing 1, the first trigger 6 activates the first sensor 3 at least once, and each activation generates a sensing signal. When the second trigger 15 activates the second sensor 4, the driving assembly 7 stops. The specification of the capsule holder on the supporting base 2 is determined based on the number of times the first sensor 3 is activated.

In one specific embodiment, the first trigger 6 is provided with at least one triggering portion. When there are two or more triggering portions, all of them are arranged from top to bottom along the lifting direction of the supporting base 2. Specifically, the capsule holders have different heights depending on their specifications, and when there are multiple triggering portions, each corresponds to a different specification of capsule holder.

In one specific embodiment, as shown in FIG. 1, the first trigger 6 is provided with three triggering portions arranged from top to bottom: a first triggering portion 61, a second triggering portion 62, and a third triggering portion 63. There are three specifications of capsule holders: a first capsule holder 8 corresponding to the first triggering portion 61, a second capsule holder 9 corresponding to the second triggering portion 62, and a third capsule holder 10 corresponding to the third triggering portion 63. The height of the first capsule holder 8 is greater than that of the second capsule holder 9, and the height of the second capsule holder 9 is greater than that of the third capsule holder 10. In this embodiment, the height of the capsule holder refers to the position of its upper end when the capsule holder is placed on the supporting base 2 while the supporting base 2 is in its lowest position, which is used to distinguish among the three specifications of capsule holders.

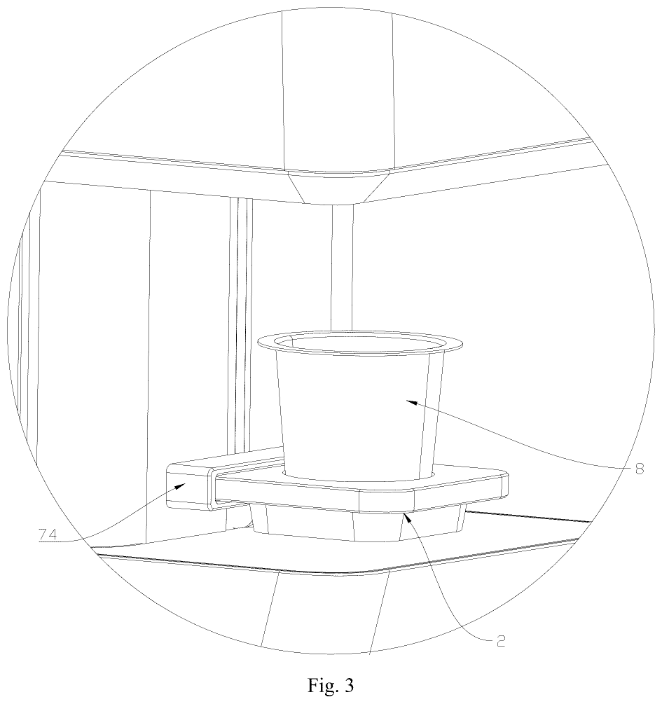

As a specific embodiment of the above solution, as shown in FIG. 3, when the driving assembly 7 drives the supporting base 2 and the capsule holder to ascend, if the first triggering portion 61 activates the first sensor 3 and then the second trigger 15 immediately activates the second sensor 4, the driving assembly 7 stops. At this time, the capsule holder reaches the engagement position with the powder discharge port, while the second triggering portion 62 has not yet reached the position to activate the first sensor 3. The system detects that the first sensor 3 has been activated once and thus identifies the capsule holder as the first capsule holder 8.

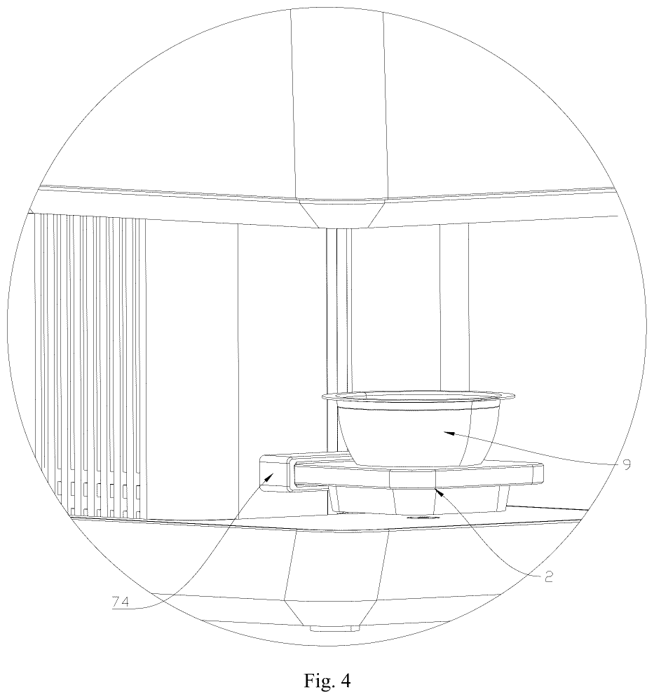

In another specific embodiment, as shown in FIG. 4, when the driving assembly 7 drives the supporting base 2 and the capsule holder to ascend, after the first triggering portion 61 activates the first sensor 3 and the second trigger 15 has not yet reached the position to activate the second sensor 4, the driving assembly 7 continues to drive the capsule holder upward. When the second triggering portion 62 then activates the first sensor 3, and immediately thereafter the second trigger activates the second sensor 4, the driving assembly 7 stops. At this point, the capsule holder precisely reaches the engagement position with the powder discharge port, while the third triggering portion 63 has not yet reached the position to activate the first sensor 3. The system detects that the first sensor 3 has been activated twice, and thus identifies the capsule holder as the second capsule holder 9.

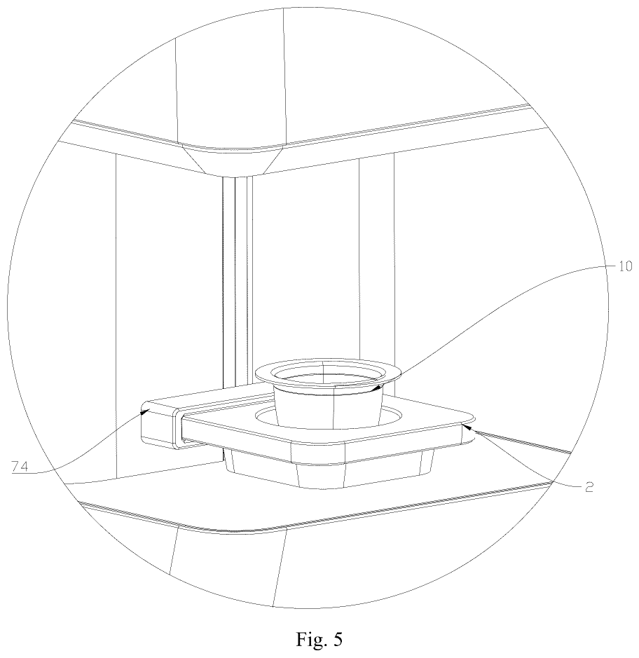

In another specific embodiment, as shown in FIG. 5, when the driving assembly 7 drives the supporting base 2 and the capsule holder to ascend, after the second triggering portion 62 activates the first sensor 3 and the second trigger 15 has not yet reached the position to activate the second sensor 4, the driving assembly 7 continues to drive the capsule holder upward. When the third triggering portion 63 then activates the first sensor 3, and immediately thereafter the second trigger activates the second sensor 4, the driving assembly 7 stops. At this point, the capsule holder precisely reaches the engagement position with the powder discharge port. The system detects that the first sensor 3 has been activated three times, and thus identifies the capsule holder as the third capsule holder 10.

In this process, when the driving assembly 7 drives the capsule holder to ascend and engage with the powder discharge port 12, the specification of the capsule holder can be automatically identified by recording the number of times the first trigger 6 activates the first sensor 3. Through the cooperation of the second trigger and the second sensor 4, capsule holders of different specifications can precisely reach the engagement position with the powder discharge port 12, and the driving assembly 7 stops accordingly, thereby preventing the capsule holder from being compressed or deformed.

In one specific embodiment, as shown in FIG. 1, in order to facilitate the installation of the first trigger 6, a connecting assembly 16 is provided between the driving assembly 7 and the supporting base 2. The driving assembly 7 drives the supporting base 2 to ascend and descend via the connecting assembly, and the first trigger 6 is mounted on the connecting assembly 16. Specifically, the supporting base 2 is positioned on the outer side of the housing 1, while the driving assembly 7 is positioned inside the housing 1 and may specifically include a drive motor and a lead screw 72. The drive motor drives the lead screw 72 to rotate. The connecting assembly includes a nut 71 sleeved on the lead screw 72, a mounting base 73 for installing the first trigger 6, and a connecting frame 74 that connects the nut 71 and the supporting base 2. One end of the connecting frame 74 is located inside the housing 1 and is connected to the nut 71, while the other end passes through the housing 1 and is connected to the supporting base 2. The first sensor 3 is a first photoelectric switch, and the first trigger 6 is a light-blocking plate, which is mounted on the mounting base 73. When there are multiple triggering portions, the number of light-blocking plates corresponds to the number of triggering portions, and they are arranged in one-to-one correspondence from top to bottom. The first photoelectric switch is preferably a slot-type infrared switch.

In another specific embodiment, the coffee capsule machine equipped with a recognition assembly 14 further includes a capsule holder disposed on the supporting base 2, and the second trigger 15 is arranged at the upper end of the capsule holder. Specifically, when the second sensor 4 is a photoelectric switch, the upper end of the capsule holder itself serves as the second trigger.

In another specific embodiment, as shown in FIG. 2, the second sensor 4 is disposed on the housing 1. When the capsule holder completes engagement with the powder discharge port 12, the second trigger 15 activates the second sensor 4, and the driving assembly 7 stops. The second sensor 4 is a second photoelectric switch, and an installation portion 11 is provided on the side of the powder discharge port 12 on the housing 1. The second photoelectric switch is preferably a through-beam infrared switch and specifically includes a receiver 41 and a transmitter 42 mounted on the installation portion 11. The receiver 41 and transmitter 42 are respectively positioned on opposite sides of the powder discharge port 12 and face each other, which facilitates installation and does not interfere with the upward movement of the capsule holder to engage with the powder discharge port 12. When the driving assembly 7 drives the capsule holder to ascend, only after the capsule holder properly engages with the powder discharge port 12 does the upper end of the capsule holder serving as the second trigger activate the second sensor 4, thereby stopping the driving assembly 7. The cooperation between the second trigger and the second sensor 4 ensures that capsule holders of different specifications can precisely reach the engagement position with the powder discharge port 12.

In another specific embodiment, as shown in FIG. 1, a third sensor 5 is also provided inside the housing 1, and the third sensor 5 is located below the first sensor 3. When the driving assembly 7 drives the supporting base 2 to descend along the housing 1, if the first trigger 6 activates the third sensor 5, the driving assembly 7 stops. Specifically, when there are multiple triggering portions on the first trigger 6, after the capsule holder has received the coffee powder, and the driving assembly 7 drives the supporting base 2 to descend along the housing 1, if the lowest triggering portion on the first trigger 6 activates the third sensor 5, the driving assembly 7 immediately stops, and the supporting base 2 stops descending and reaches the lowest position. The third sensor 5 is a third photoelectric switch, and the first trigger 6 is a light-blocking plate. The third photoelectric switch is preferably a slot-type infrared switch, and the third photoelectric switch and the first photoelectric switch are arranged along the vertical direction.

The working principle is described as follow.

When the driving assembly 7 drives the supporting base 2 and the capsule holder to ascend, and the capsule holder reaches the engagement position with the powder discharge port 12, the second trigger 15 activates the second sensor 4, causing the driving assembly 7 to stop. This ensures that the capsule holder precisely reaches the engagement position with the powder discharge port 12. At this moment, the system identifies the specification of the capsule holder by detecting the number of times the first trigger 6 has activated the first sensor 3.

When the driving assembly 7 drives the supporting base 2 and the capsule holder to descend, and the lowest triggering portion on the first trigger 6 activates the third sensor 5, the driving assembly 7 stops, allowing the supporting base 2 to reach its lowest position.

The present invention is not limited to the above optional embodiments. Provided that there is no conflict among the various solutions, the features described herein may be freely combined. Any other forms of products derived under the inspiration of the present invention shall fall within the scope of protection of the present invention, regardless of any changes made to their shapes or structures, so long as the technical solutions fall within the scope defined by the claims.

What is claimed is:

1. A coffee capsule machine equipped with recognition assembly for capsule holder specification, comprising:
a housing provided with a powder discharge port configured to interface with a capsule holder;
a capsule holder mechanism disposed on the housing, the capsule holder mechanism including a supporting base configured to place the capsule holder; and
a recognition assembly for capsule holder specification disposed on the housing and configured to identify a specification of the capsule holder placed on the supporting base.

2. The coffee capsule machine according to claim 1, wherein the capsule holder mechanism further includes a driving assembly configured to drive the supporting base to ascend along the housing such that the capsule holder on the supporting base engages with the powder discharge port, or to descend along the housing such that the capsule holder on the supporting base disengages from the powder discharge port.

3. The coffee capsule machine according to claim 2, wherein the recognition assembly for capsule holder specification comprises a first sensor and a second sensor both disposed on the housing, and a first trigger and a second trigger both disposed on the capsule holder mechanism and configured to ascend or descend synchronously with the supporting base along the housing;
when the driving assembly drives the supporting base to ascend along the housing, the first trigger activates the first sensor at least once, with each activation generating a sensing signal, and when the second trigger activates the second sensor, the driving assembly stops; the specification of the capsule holder on the supporting base is determined based on a number of activations of the first sensor.

4. The coffee capsule machine according to claim 3, wherein the first trigger is provided with at least one triggering portion;
when there are two or more triggering portions, all the triggering portions are arranged from top to bottom along a lifting direction of the supporting base.

5. The coffee capsule machine according to claim 3, wherein a connecting assembly is provided between the driving assembly and the supporting base; the driving assembly drives the supporting base to ascend or descend via the connecting assembly, and the first trigger is disposed on the connecting assembly.

6. The coffee capsule machine according to claim 3, further comprising the capsule holder disposed on the supporting base, wherein the second trigger is arranged at an upper end of the capsule holder.

7. The coffee capsule machine according to claim 6, wherein the second sensor is disposed on the housing; when an engagement between the capsule holder and the powder discharge port is completed, the second trigger activates the second sensor and the driving assembly stops.

8. The coffee capsule machine according to claim 3, wherein the first sensor is a first photoelectric switch, and the first trigger is a light-blocking plate.

9. The coffee capsule machine according to claim 3, wherein the second sensor is a second photoelectric switch, and a mounting portion is provided on a side of the powder discharge port on the housing; the second photoelectric switch comprises a receiver and a transmitter both mounted on the mounting portion, the receiver and transmitter being respectively positioned on opposite sides of the powder discharge port and facing each other.

10. The coffee capsule machine according to claim 3, wherein a third sensor is further provided inside the housing, and the third sensor is located below the first sensor;
during the driving assembly drives the supporting base to descend along the housing, once the first trigger activates the third sensor, the driving assembly stops.

11. The coffee capsule machine according to claim 10, wherein the third sensor is a third photoelectric switch, and the first trigger is a light-blocking plate.
